(19) United States
(12) Patent Application Publication
(10) Pub. No.: US 2019/0186145 A1
(43) Pub. Date: Jun. 20, 2019

(54) ROOFTOP WIND TURBINE FLOW IMPROVEMENTS

(71) Applicant: Mark Daniel Farb, Lawrence, NY (US)

(72) Inventor: Mark Daniel Farb, Lawrence, NY (US)

(73) Assignee: Flower Turbines, Lawrence, NY (US)

(21) Appl. No.: 16/324,720

(22) PCT Filed: Aug. 30, 2017
(86) PCT No.: PCT/IL2017/050969

§ 371 Date: Feb. 11, 2019

Related U.S. Application Data
(60) Provisional application No. 62/384,732, filed on Sep. 8, 2016.

(51) Int. Cl. E04D 13/15; F03D 13/20; F03D 9/45

(52) U.S. Cl. CPC E04D 13/15; F03D 13/20; F05B 2240/9112; F05B 2240/13; F05B 2240/211; F03D 9/45

(57) ABSTRACT

One of the challenges of rooftop wind turbines is that the building causes turbulence and updrafts and can create a blockage to the wind at rooftop level. That means lower speed and higher turbulence wind hitting the turbine and less power output. Prior art solutions consisted of elevating the blades of rooftop turbines or making the updraft hit the blades. Creating structures that separate the turbulence of the air below roof level from the oncoming and higher velocity linear wind above roof level, where the turbine is located, can decrease slowing of the rooftop level wind stream and enable the blades to be placed closer to roof level, thereby saving construction costs and roof weight. It is ideal to combine these improvements with a vertical axis wind turbine.

### STATEMENT REGARDING PRIOR DISCLOSURES BY THE INVENTOR OR A JOINT INVENTOR

This patent application claims the benefit of U.S. Provisional Patent Application No. 62217895, entitled Provisional 9-16, filed Sep. 7, 2016.

### CROSS REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not applicable

### BACKGROUND OF THE INVENTION

The present invention relates to a way to affect rooftop wind so that the building interferes less with the production of power by the rooftop turbines. Of course, this can be applied, and this application means for it to apply, to any similar landscape, and can apply to underwater turbines and seascapes as well.

Prior research has noted the problems with turbulent wind on rooftops but mostly has looked at a solution for it as an avoidance of obstacles, usually on the surface of the roof: “The rule of thumb is that the turbine should be at least 9 m (30 ft) higher than any obstacle within 150 m (500 ft):” One reference identifies the problem with no solution: “Even worse, all the obstacles—trees, other buildings, even the house itself—cause turbulence in the wind.” (http://www.engineering.com/ElectronicsDesign/ElectronicsDesignArticles/ArticleID/9556/Roof top-Wind-Turbines-Are-They-Worthwhile.aspx)

The review article, Wind Turbines in the Urban Environment (http://www.ragheb.co/NPRE%20475%20Wind%20Power%20Systems/Wind%20Turbines%20i n%20the%20Urban%20Environment.pdf), shows no evidence of prior art of reshaping the building's edge or top. In fact, its FIG. 1 (similar to FIG. 1 here) shows the problem of a building edge rather nicely, and also the currently used solution of locating the blades above the turbulence level. This elevation of the turbine involves significant expense and difficulty in obtaining zoning permits.

The article's FIG. 12 is a different solution using a duct, but it relies on using a horizontal axis turbine turned on its side that still obtains wind at an angle to the blades. This has the disadvantages of less power from the angled vectors and faster deterioration of the turbine from unbalanced forces, so it does not really solve the problem. In addition, the duct setup, in which there is a blocking wall to the right of the turbine, substantially decreases the speed of the flow.

U.S.20070222225 shows a structure for obtaining this wind by using a deflector above the level of the turbine, a turbine with a horizontal axis, and a sloped obstruction (meaning either a sloped building or a sloped roof). Its claim 1 teaches a surface facing an oncoming wind that deflects. It would not apply to buildings with straight sides or non-horizontal axis turbines. Its construction is somewhat simplistic, as it does not consider the well know likelihood of induced turbulence by the shape displayed in the first figure.

U.S.20070176431 teaches a horizontal wind turbine, placement at the edge, and an adjustable concentrator (350). All the configurations have a blocking structure, whether (311) or (411), to block the inferior wind from hitting the blades on their return path. This is a substantial weakness of the invention, as it introduces greater turbulence by extending the height of the outside wall. Its major independent claim 1 is a very broad claim about the passive concentration of wind flow by the vertical side of the building. This hardly addresses the problem accurately shown in his FIG. 1A of the edge of the building causing a region of lower velocity wind. This was later translated into patents U.S. Pat. No. 8,257,020 and U.S. Pat. No. 7,315,093. The new claim 1 specifically indicates that positioning within a vortex is part of the invention and that the deflection is downward.

Both of these patents block part of the wind flow. If the turbine would be a vertical axis turbine, such screening would be counter-productive because it would block wind coming from other directions and block a portion of the blades. The use of a horizontally oriented turbine has the major disadvantage of deficient handling of wind directions not perfectly aligned with the turbine. They aim to deflect flow to an area underneath the deflector; their turbine is at a height inferior to the deflector.

Another way of handling the updrafts is employed by one small wind turbine manufacturer—by taking horizontal axis turbines and angling them over the edge of the roof However, this involves no change to the building rooftop itself. And in addition, horizontal axis turbines have the disadvantage of creating large amounts of vibration on a building. One example of a patent using this approach is U.S. Pat. No. 7,276,809.

In the opinion of this applicant, none of the above solves the problem, because they are all trying to direct lower velocity turbulent air to the turbine. The applicant believes that a better solution is to separate the turbulent air aerodynamically by directing it away from the turbine blades in such a way that the normal high-velocity, high elevation wind is free to impact the turbine. Although superficially some of the solutions may look similar, small changes result in an opposite approach and much better results. The applicant's techniques for implementing a different approach make use of designs for decreasing wind load on rooftops.

Aerodynamic Mitigation of Extreme Wind Loading on Low-rise Buildings by Kevin Sehn (2008), Retrospective Theses and Dissertations.Paper 15366, Iowa State University, found at http://lib.dr.iastate.edu/cgi/viewcontent.cgi?article=16365&context=rtd, talks about mitigating hurricane winds from buildings. However, this can be applied to our problem here. He found that the three best methods for diminishing uplift forces on rooftops were the flush edge spoiler, then the PPE (passive pressure equalization), then the 10% PCR (porous canopy roof) models. To some extent, our problem here has some similarities to rooftop mitigation. We want to decrease turbulence and to decrease edge effects and shear layers. The prior art cited above shares some turbine.

The flush edge spoiler model is described in the article. Its FIG. 3.7 shows how such a design can disrupt the usual roof turbulence. It shows how a mostly horizontal structure, especially one with a slightly raised roof ledge, can disrupt the normal roof turbulence. “The edge spoiler is made out of a flat strip of aluminum that is fixed slightly above the roof of the gable base model as shown in FIG. 3.7.”

“The passive roof pressure equalization method uses pressure tubing to connect openings on the windward side to openings on the leeward side of the roof.” This model can be seen in FIG. 3.9.

The porous canopy roof model enables passive communication above and below a roof covering.

In summary, the current invention is distinguished from prior art in a number of ways:

It uses the rooftop without structures above the level of the turbines or even on their level so that the fluid flow is unimpeded.

It uses some ideas from a different industrial class and applies them in a unique way to the problem of rooftop wind. As is clear from the references cited, even experts in the field did not think of these solutions.

It creates an environment of much more laminar flow into the turbines. The author of one of the patents cited specifically wanted to direct turbulent air into the turbine. The applicant believes this was a mistake.

It does not require substantial elevation above the turbulence layer, which, in the research paper cited, is about 20-25% of the height of the building.

In summary, the current application offers solutions to the issue of rooftop wind based on scientific principles of using pressure differences and deflection to direct turbulent wind away from a vertical axis rooftop turbine.

### BRIEF SUMMARY OF THE INVENTION

The present invention successfully addresses the shortcomings of the presently known configurations by providing a structural solution to an aerodynamic problem of buildings interfering with the quality of wind on their rooftops.

It is now disclosed for the first time a system of flow redirection away from blades of a turbine, that generates energy by spinning on a shaft connected to a generator, said turbine located on a platform, said platform higher than its surroundings, possessing at least one edge in a prevailing direction of substantially horizontal flow, upstream of the edge of said platform, said flow impacting on both the vertical surface and the area above the platform, said upstream flow below the platform level converting to a partially vertical flow after impacting on the vertical surface, and a substantially vertical surface inferior to and adjacent to the at least one edge of said platform, said vertical surface fixedly attached to said platform, comprising:

said turbine is above and connected to said platform, and is downstream from the edge,
said platform not having a vertical extension downstream from the turbine substantially at the height of the blades for the distance of at least one blade diameter of the turbine,
said platform not having a vertical extension upstream from the platform that is on a level of height substantially equal to and above the lowest part of the blades,
a redirection structure adjacent to and in fixed communication with the platform, below the height of the blades, that serves to redirect the vertical flow substantially horizontally away from and below the blades of the turbine and maintain substantially the same speed of horizontal flow to the turbine blades as is present in the prevailing flow speed.

According to another embodiment, the turbine is a drag type.

According to another embodiment, the redirection structure is a substantially horizontal projection upstream from the turbine within a range slightly above or below the platform level and adjacent to the vertical surface.

According to another embodiment, the extent of the projection is 3 centimeters/meter of vertical height of the structure below the platform, plus or minus a centimeter, for the first 50 meters. The applicant's team has performed simulations that suggest this is the correct formula to avoid turbulence.

According to another embodiment, the projection extends a minimum of 1 meter.

According to another embodiment, the projection is above the level of the platform.

According to another embodiment, the redirection structure is a flush edge spoiler. Note that making the angle more parallel to the platform makes the spoiler perform better. According to another embodiment, the spoiler further comprises fins on the underside of the spoiler in parallel with the flow.

According to another embodiment, the redirection structure is a partial pressure equalizer.

According to another embodiment, the redirection structure is a porous canopy roof.

According to another embodiment, herein the redirection structure is a rounded edge.

According to another embodiment, the platform is a rooftop of a building.

It is now disclosed for the first time a method of directing flow away from turbine with blades, that generate energy by spinning on a shaft connected to a generator, said turbine located on a platform, said platform higher than its surroundings, possessing at least one edge in a prevailing direction of substantially horizontal flow, upstream of the edge of said platform, said flow impacting on both the vertical surface and the area above the platform, said upstream flow below the platform level converting to a partially vertical flow after impacting on the vertical surface, and a substantially vertical surface inferior to and adjacent to the at least one edge of said platform, said vertical surface fixedly attached to said platform, wherein said turbine is above and connected to said platform, and is downstream from the edge, providing

said platform not having a vertical extension downstream from the turbine substantially at the height of the blades for the distance of at least one blade diameter of the turbine,
said platform not having a vertical extension upstream from the platform that is on a level of height substantially equal to and above the lowest part of the blades,
providing a redirection structure adjacent to and in fixed communication with the platform, below the height of the blades, that serves to redirect the vertical flow substantially horizontally away from and below the blades of the turbine and maintain substantially the same speed of horizontal flow to the turbine blades as is present in the prevailing flow speed.

According to another embodiment, the turbine is a vertical axis type.

According to another embodiment, the turbine is a drag type.

The present invention successfully addresses the shortcomings of the presently known configurations of wind turbines on rooftops or equivalent natural geographies by providing rooftop structures and designs that improve the laminarity of the flow on rooftops.

### BRIEF DESCRIPTION OF SEVERAL VIEWS OF THE DRAWINGS

The invention is herein described, by way of example only, with reference to the accompanying drawings, wherein:

FIG. 1 is a diagram of the problem of a flat roof

FIG. 2 is a diagram of the problem of a rounded roof .

FIG. 3 is a diagram of a rooftop turbine and an awning.

FIG. 4 is a diagram of a rooftop turbine and a flush edge spoiler.

FIG. 5 is a diagram of two better versions of the spoiler.

FIG. 6 is a diagram of a rooftop turbine and a PPE.

FIG. 7 is a diagram of a rooftop turbine and a PCR.

FIG. 8 is a diagram of fins attached to a spoiler.

### DETAILED DESCRIPTION OF THE INVENTION

The present invention makes rooftop wind energy much more practical, and solves the problem of the wind distortion, caused by the building, on the rooftop.

Definitions: For the sake of specific language, the rooftop is referred to in the claims as a platform, meaning a flat surface higher than its surroundings, and the side of the building as a vertical surface, even if it is not exactly at 90 degrees. This is done to keep the principles general enough so that they can apply to many situations, such as an underwater turbine on a platform under the water, or a building with an atypical shape. Downstream is taken to mean the same as downwind; that means an area farther away in the direction of flow.

The principles and operation of making a rooftop accommodate wind turbines by removing obstacles and turbulence according to the present invention may be better understood with reference to the drawings and the accompanying description.

The present invention solves the problem of buildings creating obstacles to flow and shows new solutions for how to solve that problem.

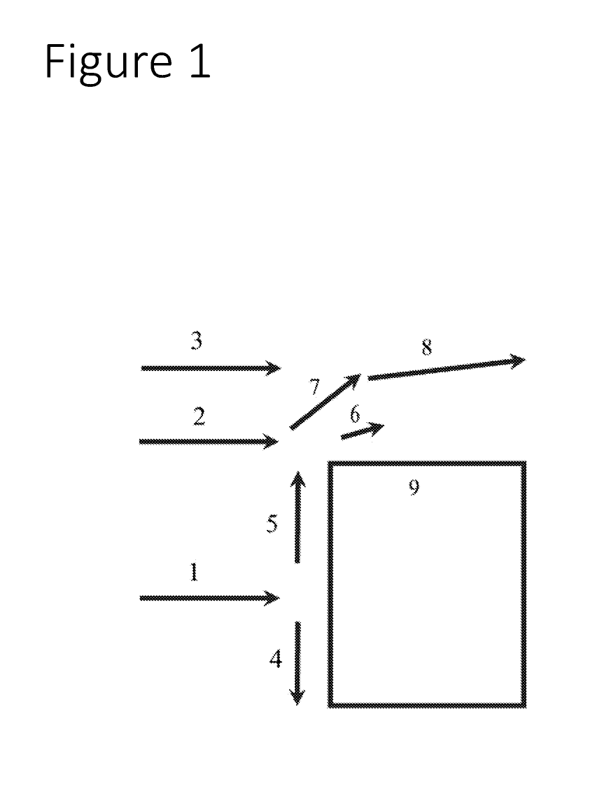

Referring now to the drawings, FIG. 1 illustrates in a cross-sectional view from the side the problem with the current understanding of how to build rooftops on buildings. Complex wind patterns can occur on the roofs of buildings that include interference with laminar flow to turbines, whether by creating unwanted vectors or vortices. This diagram shows why one must elevate the turbines by a large amount in order to provide them with good wind. (9) is the building. (1) shows the vector of the wind in the direction of the building. (2) shows the vector of oncoming wind just above roof level. (3) shows the vector of oncoming wind higher above roof level. As the wind on building level (1) hits the obstacle of the building, it splits into vector (4) going down and vector (5) going up. (It also splits to the side, but that is not the focus of the current application.) As (5) hits (2), it results in lower velocity wind along the rooftop and higher velocity vectors (7) and then (8) on a higher level. This is the explanation of the prior art technique quoted above of elevating the turbine blades by a substantial amount. The vectors shown generally indicate by their length in a conceptual fashion the relative velocities of the airflow.

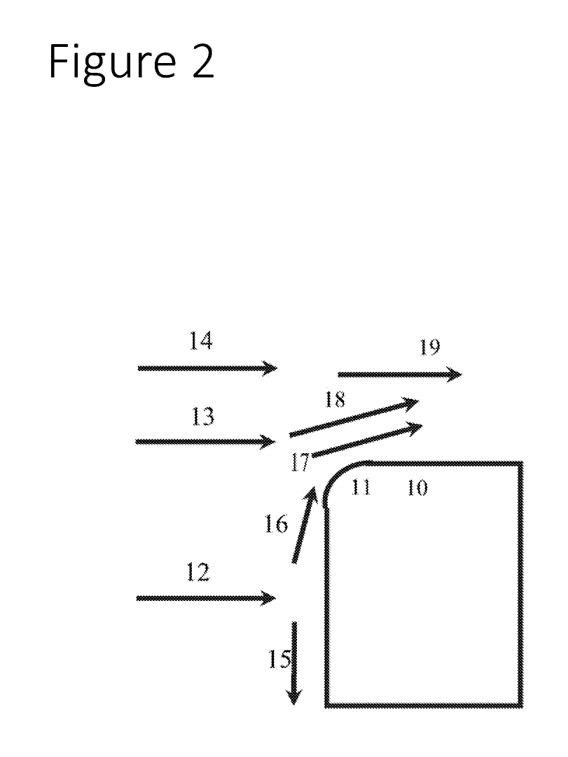

FIG. 2 illustrates in another cross section from the side how the rooftop wind would appear in a rounded roof edge environment. The addition of or initial construction of a rounded edge is not prior art, and the current application discloses it as one of a series of possible solutions but not the best. (It is possible to use the solutions described in this application in synergy with each other.) There is a building rooftop (10) with a rounded rooftop (11) in the direction of oncoming wind. (12) is the vector of wind hitting the building. (13) is the vector of wind just above rooftop level. (14) is the vector of wind substantially above rooftop level.

Oncoming wind (12) splits into vectors (15) and (16) from the obstacle of the building. As wind from vectors (13) and (16) meet, vectors (17) and (18) are produced. They are more horizontal at rooftop level and higher velocity than in FIG. 1, but they still have an upward vector. At a higher level, the wind follows vector (19). This return of the wind to normal occurs at a level vertically closer to the roof than in FIG. 1. An architect seeking to enhance rooftop wind installation would likely build the element (11) of FIG. 2 into the building, or make an add-on curved structure.

Needless to say, the areas of wind blocked by the building result in turbulence and vortices that interfere with wind speed to a turbine placed on a rooftop. The figures in this application do not show these details of turbulence as they are only important for the reader's understanding, not for the claims.

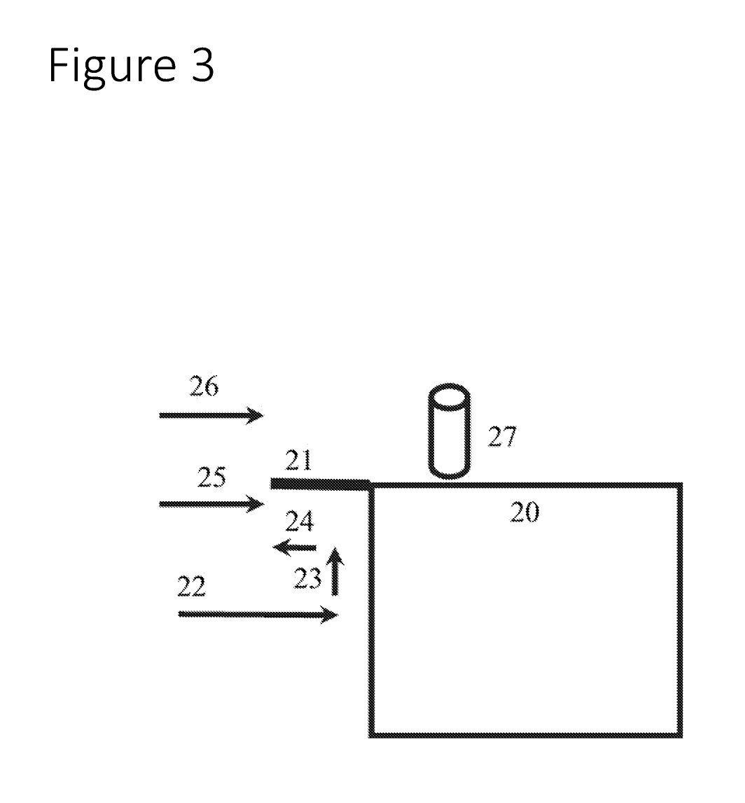

FIG. 3 illustrates a rooftop (20) and an awning (21) for use with a rooftop wind turbine (27) in a side cross sectional view. An awning is a substantially horizontal extension from the roof. The ideal horizontal extension is 3 centimeters for each meter of height from the roof, so that a 10-meter house would ideally have an awning of 30 centimeters, and a 35-meter building would have an awning of 105 centimeters. Less than this, the effectiveness should diminish. Beyond much more than this amount, it may not be so practical, and may not add much more effect, so realistically it would ideally be a minimum of 3 centimeters per meter, plus or minus 1 centimeter, for the first 50 meters, or, alternatively, for a minimum of 1 meter. (These numbers are based on data from Computational Fluid Dynamics simulations.) It is ideally at roof level but can be below roof level. The awning, which can be of any material, can have in one embodiment openings to enable equalization of pressure. The objective of this arrangement, and the others that follow, is to present less impeded air to the turbine.

The purpose of an extended rooftop awning is to separate the turbulence caused by the wind striking the building from the more laminar flow without the building's interference. Vector (22) shows the wind hitting the building in its middle; vector (25) shows it hitting just below the awning, shown in this embodiment as being at rooftop level, but it can be at a different level. Some wind (23) then travels vertically, hits the barrier of the awning (21), and reroutes as vector (24), which then interacts with vector (25) to form additional turbulence. This turbulence is confined by the awning to the area below rooftop level, thereby allowing the wind oncoming above rooftop level (27) to hit the turbine with minimal if any impedance.

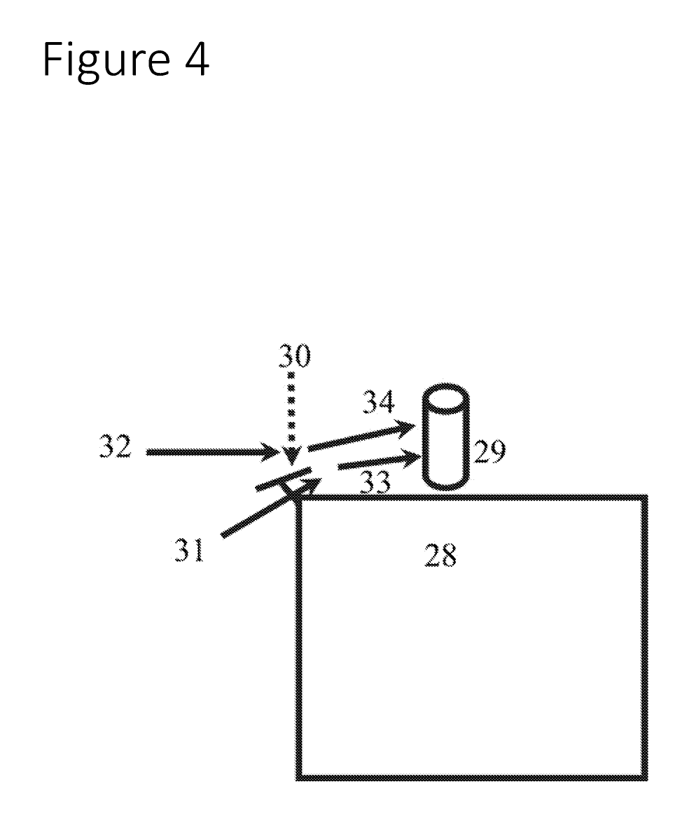

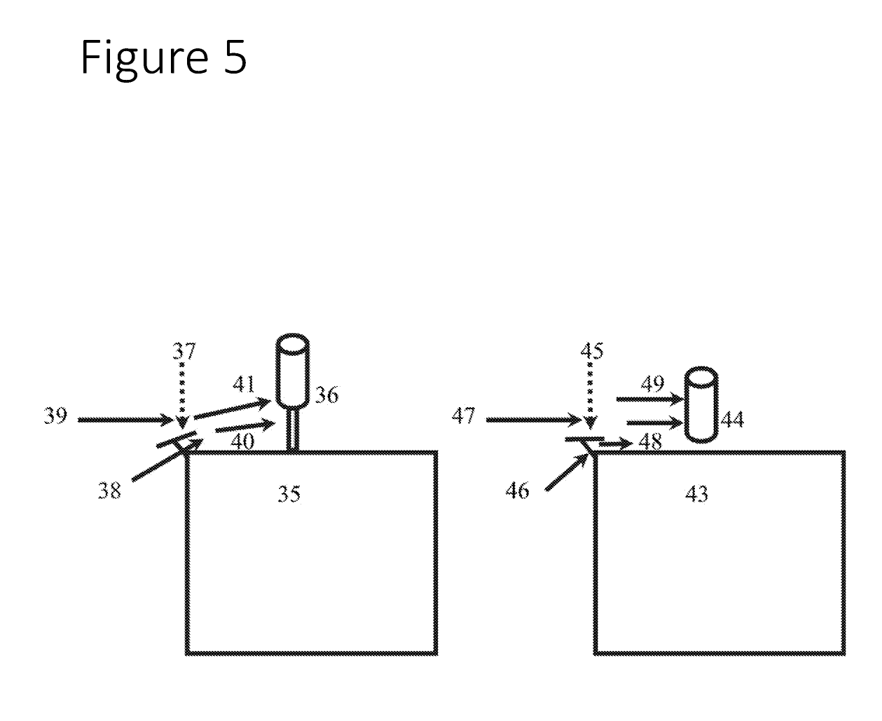

FIG. 4 shows a building rooftop (28) and a turbine (29) with a flush edge spoiler (30) located near the edge of the roof in order to equalize the pressures. The spoiler is a flat area separate from the edge of the roof, attached to it by arms, sufficient for airflow above and below it to be separated. The spoiler moves the slower, high pressure air in the desired direction, towards the turbine, by creating a communication between the higher pressure air on the side of the building (31) with the lower pressure air on the rooftop (33), instead of this mixing occurring before the rooftop. The laminar oncoming wind above rooftop level (32) is deflected slightly upwards (vector 34) towards the turbine and also pushes the air stream coming from the underside of the spoiler (30) as vector (33) towards the lower part of the turbine. In wind, unequal pressures are related to unequal velocities in a reciprocal manner, so that high pressure areas have lower velocities. (Note that the illustration is a side view, so it shows vector (31) passing through spoiler (30) because the spoiler has arms attaching it to the platform, but it is otherwise hollow.) This results in some improvements, but the drawbacks are that energy is lost both through turbulence and through the angular vectors of wind hitting the turbine. Note that the prior art presents this spoiler as angled at approximately 45 degrees but does not state any particular angle. The current application shows a better angle in FIG. 5.

FIG. 5 shows two ways to avoid the problems of FIG. 4. On the left is a building rooftop (35) and a turbine (36) with a flush edge spoiler (37) located near the edge of the roof. The deflected air from the side of the building (38) now hits the spoiler and is deflected towards the base of the turbine, with the lower pressure air on the rooftop (40), below the level of the turbine. The laminar oncoming wind above rooftop level (39) is deflected only slightly upwards (vector 41) towards the turbine blades and also pushes the air stream coming from the underside of the spoiler (37) as vector (40) towards the lower part of the turbine. This works better aerodynamically, but still forces the turbine to be elevated substantially.

The best solution is on the right. The different angle of the spoiler (45) causes the rising air (46) from the building (43) to be deflected (48) to the base of the turbine (44). The linear oncoming air (45) is now very laminar and higher speed and hits the turbine with a horizontal vector (49). Now the wind is more laminar and higher velocity, and the turbine can be close to the platform, or roof, surface. This is an advantage.

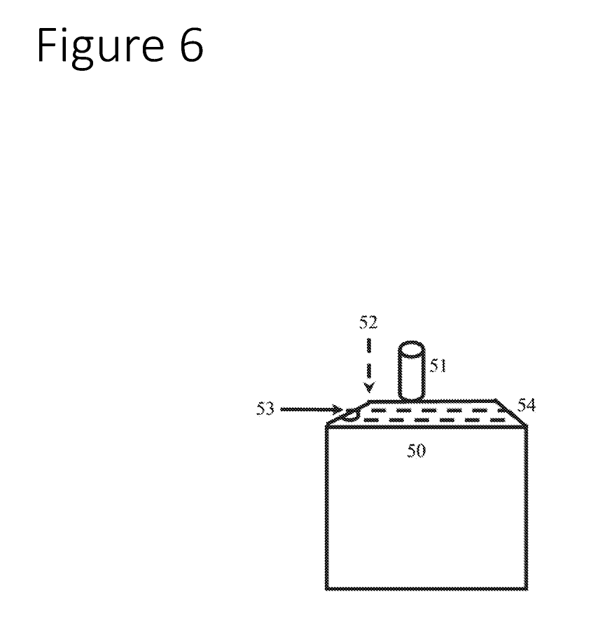

FIG. 6 shows a building (50) and a turbine (51) on a slightly raised platform (52), which has tubes enabling the wind to pass from (53) to (54) to equalize the pressure from one side to the other. This is passive pressure equalization. The tubes can pull higher pressure to an area of lower pressure, and cause decreased interference with laminar flow above.

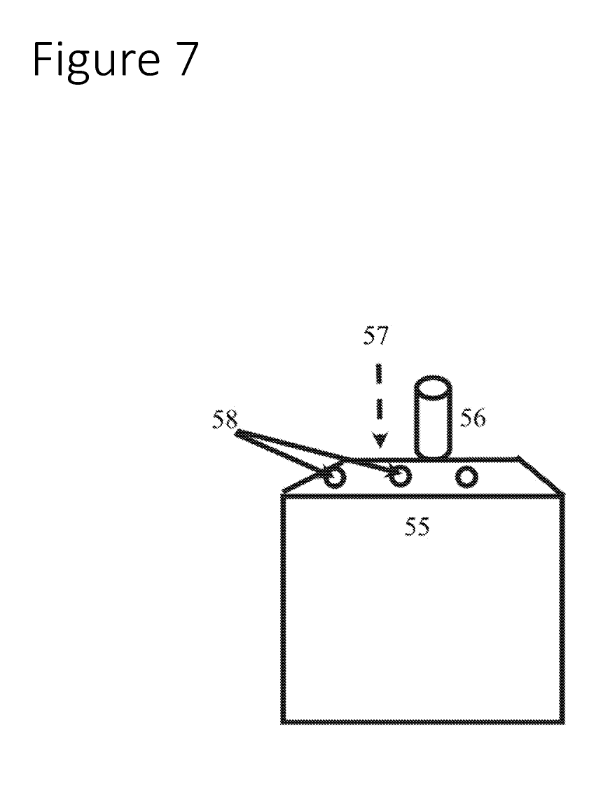

FIG. 7 shows a building (55), turbine (56) on a slightly raised platform (57), which has vertically disposed holes (58) and open areas along the sides of the platform to equalize the pressure. This is called PCR for “porous canopy roof.” This draws turbulent wind below the level of the turbine.

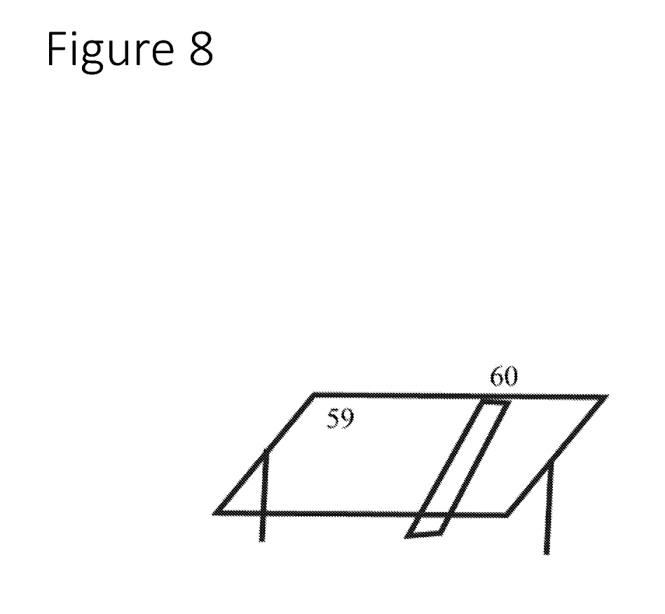

FIG. 8 is an improvement to the spoiler concept in any manifestation. The spoiler (59) has fins (60) on the underside of the spoiler panel in order to decrease turbulence. In one embodiment, they are parallel to the upstream/downstream flow as shown. In another embodiment, they flare outwards as they approach the turbine in order to disperse turbulent wind.

While the invention has been described with respect to a limited number of embodiments, it will be appreciated that many variations, modifications and other applications of the invention may be made. The basic concept is to eliminate vortices and blocking masses of air from the area upstream to the wind turbines.

Clearly, these may be made in all directions, but it is most practical to do so in the direction of most prominent wind.

Although the term “wind” was used in this application since this would be the most common use for the invention, it really can be applied to any fluid.

While the invention has been described with respect to a limited number of embodiments, it will be appreciated that many variations, modifications and other applications of the invention may be made.

With the figures above, one can now understand the current independent claims better. The closest prior art would resemble FIG. 4, but the current application would resemble FIG. 5. FIG. 5 on the right shows a solution likely to be better than that of FIGS. 6 and 7. In addition, the current application shows other ways to achieve the desired results in the context of the principles of claim 1 through the structures shown in FIGS. 6 and 7. There is no reason that more than one of the solutions of FIGS. 5, 6, and 7 cannot be used together.

Let us analyze how claim 1 fits in with the figures and differs from prior art: (comments in brackets)
1. A system of flow redirection away from blades of a turbine [FIGS. 4 and 5], that generates energy by spinning on a shaft connected to a generator, said turbine located on a platform, said platform higher than its surroundings, possessing at least one edge in a prevailing direction of substantially horizontal flow, upstream of the edge of said platform, said flow impacting on both the vertical surface and the area above the platform, said upstream flow below the platform level converting to a partially vertical flow after impacting on the vertical surface [this is all part of the preface, just defining a building in the sense of the problem this application addresses], and a substantially vertical surface inferior to and adjacent to the at least one edge of said platform, said vertical surface fixedly attached to said platform, comprising:
   said turbine is above and connected to said platform, and is downstream from the edge, [distinction that it is not on the edge, to differentiate from patents such as U.S. Pat. No. 7,276,809]
   said platform not having a vertical extension downstream from the turbine substantially at the height of the blades for the distance of at least one blade diameter of the turbine [this is to make sure that the roof surface is open of other interferences, and is an additional limitation not addressed by prior art],
   said platform not having a vertical extension upstream from the platform that is on a level of height substantially equal to and above the lowest part of the blades, [this is an integral part of some of the prior art; they have a vertical extension that blocks the wind from hitting the lower part of the blades; this causes more turbulence and is also different structurally since the current application uses blades of a type whereby hitting the entire turbine is desired]
   a redirection structure adjacent to and in fixed communication with the platform, below the height of the blades [important distinction; in the prior art, it was above; that choice blocks the higher velocity air above from hitting the turbine], that serves to redirect the vertical flow substantially horizontally away from and below the blades of the turbine [in other words, so it won't interfere with the functioning of the blades] and maintain substantially the same speed of horizontal flow to the turbine blades as is present in the prevailing flow speed [that is, that the speeds of vectors 47 and 49 should be substantially the same].

What is claimed is:

1. A system of flow redirection relative to blades of a turbine, said turbine generating energy by spinning on a shaft connected to a generator and located on a platform, said platform higher than its surroundings, possessing at least one edge with a vertical surface inferior to and adjacent to the at least one edge of said platform, said vertical surface fixedly attached to said platform, in a direction of substantially horizontal flow, said flow upstream of the edge of said platform, said flow impacting on both the vertical surface and the area above the platform, said upstream flow below the platform level converting to a partially vertical flow after impacting on the vertical surface, comprising:
A redirection structure adjacent to and in fixed communication with the platform, said redirection structure having a flow entry area and a flow exit area, said flow exit area pointing away from the blades,
said turbine is above and connected to said platform, and is downstream from the edge,
said platform not having a vertical extension downstream from the turbine substantially at the height of the blades for the distance of at least one blade diameter of the turbine,
said platform not having a vertical extension upstream from the platform that is on a level of height substantially equal to and above the lowest part of the blades,
said redirection structure operative to redirect the vertical flow substantially horizontally away from and below the blades of the turbine.

2. The system of claim 1, wherein the turbine is a drag type.

3. The system of claims 1 and 2, wherein the redirection structure is a substantially horizontal projection upstream from the turbine within a range slightly above or below the platform level and adjacent to the vertical surface.

4. The system of claim 3, wherein the extent of the projection is 3 centimeters/meter of vertical height of the structure below the platform, plus or minus a centimeter, for the first 50 meters

5. The system of claim 3, wherein the projection extends a minimum of 1 meter.

6. The system of claim 3, wherein the projection is above the level of the platform.

7. The system of claims 1 and 2, wherein the redirection structure is a flush edge spoiler.

8. The system of claim 7, further comprising fins on the underside of the spoiler in parallel with the flow.

9. The system of claims 1 and 2, wherein the redirection structure is a partial pressure equalizer.

10. The system of claims 1 and 2, wherein the redirection structure is a porous canopy roof.

11. The system of claims 1 and 2, wherein the redirection structure is a rounded edge.

12. The system of claims 1-11, wherein the platform is a rooftop of a building.

13. A method of directing flow away from turbine with blades, said turbine generating energy by spinning on a shaft connected to a generator and located on a platform, said platform higher than its surroundings, possessing at least one edge with a vertical surface inferior to and adjacent to the at least one edge of said platform, said vertical surface fixedly attached to said platform, in a direction of substantially horizontal flow, said flow upstream of the edge of said platform, said flow impacting on both the vertical surface and the area above the platform, said upstream flow below the platform level converting to a partially vertical flow after impacting on the vertical surface, wherein said turbine is above and connected to said platform, and is downstream from the edge, providing:
A redirection structure adjacent to and in fixed communication with the platform, said redirection structure below the height of the blades and having a flow entry area and a flow exit area, said flow exit area pointing away from and below the blades,
said platform not having a vertical extension downstream from the turbine substantially at the height of the blades for the distance of at least one blade diameter of the turbine,
said platform not having a vertical extension upstream from the platform that is on a level of height substantially equal to and above the lowest part of the blades,
a redirection structure adjacent to and in fixed communication with the platform, below the height of the blades, that serves to redirect the vertical flow substantially horizontally away from and below the blades of the turbine and maintain substantially the same speed of horizontal flow to the turbine blades as is present in the prevailing flow speed.

14. The method of claim 13, wherein the turbine is a vertical axis type.

15. The method of claim 14, wherein the turbine is a drag type.
